(19) United States
(12) Patent Application Publication
(10) Pub. No.: US 2008/0150933 A1
(43) Pub. Date: Jun. 26, 2008

(54) DISPLAY DEVICE AND DRIVING METHOD THEREOF

(75) Inventors: Naobumi Toyomura, Kanagawa (JP); Katsuhide Uchino, Kanagawa (JP); Tetsuro Yamamoto, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 11/948,291

(22) Filed: Nov. 30, 2007

(30) Foreign Application Priority Data
Dec. 26, 2006 (JP) 2006-348946

(51) Int. Cl. G06F 3/038

(52) U.S. Cl. 345/214

(57) ABSTRACT

Disclosed herein is a display device including a pixel array unit and a driving unit configured to drive the pixel array unit. The pixel array unit includes scanning lines in a form of rows, signal lines in a form of columns, pixels in a form of a matrix, the pixels being arranged at parts where the scanning lines intersect the signal lines, and feeders arranged in correspondence with respective rows of the pixels. The driving unit includes a controlling scanner, a power supply scanner, and a signal selector.

### CROSS REFERENCES TO RELATED APPLICATIONS

The present invention contains subject matter related to Japanese Patent Application JP 2006-348946, filed in the Japan Patent Office on Dec. 26, 2006, the entire contents of which being incorporated herein by reference.

### BACKGROUND OF THE INVENTION

1. Field of the Invention

The present invention relates to an active matrix type display device using a light emitting element in a pixel, and a driving method of the display device.

2. Description of the Related Art

Development of flat-panel emissive display devices using an organic EL device as a light emitting element has recently been actively underway. The organic EL device uses a phenomenon in which an organic thin film emits light when an electric field is applied to the organic thin film. The organic EL device is driven with an applied voltage of 10 V or lower, and thus consumes low power. In addition, the organic EL device is a self-luminous element that emits light by itself. Therefore a need for an illuminating member is eliminated, and it is thus easy to achieve a reduction in weight and a reduction in thickness. Further, the organic EL device has a very high response speed of a few μs, so that no afterimage occurs at a time of displaying a moving image.

Of flat-panel emissive display devices using an organic EL device in a pixel, active matrix type display devices having a thin film transistor as a driving element in each pixel in an integrated manner, in particular, are being actively developed. Active matrix type flat-panel emissive display devices are described in the following Patent Documents 1 to 5, for example.

Patent Document 1:

Japanese Patent Laid-open No. 2003-255856

Patent Document 2:

Japanese Patent Laid-open No. 2003-271095

Patent Document 3:

Japanese Patent Laid-open No. 2004-133240

Patent Document 4:

Japanese Patent Laid-open No. 2004-029791

Patent Document 5:

Japanese Patent Laid-open No. 2004-093682

### SUMMARY OF THE INVENTION

In existing active matrix type flat-panel emissive display devices, however, transistors driving light emitting elements are varied in threshold voltage and mobility due to process variations. In addition, the characteristics of organic EL devices vary with the passage of time. Such characteristic variations of the driving transistors and such characteristic variations of the organic EL devices affect light emission luminance. In order to control the light emission luminance at a uniform level over the entire screen of the display device, the characteristic variations of the transistor and the organic EL device described above within each pixel circuit need to be corrected. Display devices having a function of such a correction in each pixel have traditionally been proposed. However, the pixel circuit having an existing correcting function needs wiring for supplying a potential for the correction, a switching transistor, and a switching pulse. The pixel circuit therefore has a complex configuration. Many constituent elements of the pixel circuit have been a hindrance to achievement of higher definition of the display.

In view of the above-described problems of the conventional techniques, it is desirable to provide a display device and a driving method thereof that make it possible to achieve high definition of a display by simplifying a pixel circuit. It is particularly desirable to provide a display device and a driving method thereof that can suppress variations in light emission luminance between pixels, which variations occur with the simplification of a pixel circuit. Accordingly the following measures are taken. A display device according to an embodiment of the present invention basically includes a pixel array unit and a driving unit for driving the pixel array unit. The pixel array unit includes scanning lines in a form of rows, signal lines in a form of columns, pixels in a form of a matrix, the pixels being arranged at parts where the scanning lines intersect the signal lines, and feeders arranged in correspondence with respective rows of the pixels. The driving unit includes: a controlling scanner for sequentially supplying a control signal to the scanning lines and performing line-sequential scanning of the pixels in row units; a power supply scanner for supplying the feeders with a power supply voltage switching between a first potential and a second potential in accordance with the line-sequential scanning; and a signal selector for supplying the signal lines in the form of columns with a signal potential of a video signal and a reference potential in accordance with the line-sequential scanning. The pixels each include a light emitting element, a sampling transistor, a driving transistor, and a storage capacitor. A gate of the sampling transistor is connected to the scanning line, one of a source and a drain of the sampling transistor is connected to the signal line, and the other is connected to a gate of the driving transistor. One of a source and a drain of the driving transistor is connected to the light emitting element, and the other is connected to the feeder. The storage capacitor is connected between the source and the gate of the driving transistor. The power supply scanner switches the feeder from the first potential to the second potential in predetermined timing. During a time period when the signal line is at the reference potential, the controlling scanner supplies a control signal to the scanning line to make the sampling transistor conduct and apply the reference potential from the signal line to the gate of the driving transistor, and the second potential is set from the feeder to the source of the driving transistor. Next, the power supply scanner operates to switch the feeder from the second potential to the first potential during the time period when the signal line is at the reference potential, and write a voltage corresponding to a threshold voltage of the driving transistor to the storage capacitor. Next, during a time period when the signal line is at a signal potential, the controlling scanner supplies a control signal to the scanning line to make the sampling transistor conduct, whereby the signal potential is sampled and written to the storage capacitor, and in timing in which the storage capacitor holds the signal potential, the controlling scanner cancels application of the control signal to the scanning line to set the sampling transistor in a non-conducting state, whereby the gate of the driving transistor is electrically disconnected from the signal line. The driving transistor is supplied with a current from the feeder at the first potential, and sends a driving current to the light emitting element according to the signal potential retained by the storage capacitor. The light emitting element starts emitting light according to the driving current, and the gate potential of the driving transistor is interlocked with the source potential of the driving transistor, whereby a voltage between the gate and the source is maintained at a constant level. As a characteristic point, the reference potential of the signal line and the second potential of the feeder are set in advance such that the source potential of the driving transistor immediately before a start of light emission of the light emitting element does not exceed a threshold voltage of the light emitting element. Incidentally, when the storage capacitor retains the signal potential, the sampling transistor adds a correction for mobility of the driving transistor to the signal potential.

According to one embodiment of the present invention, in an active matrix type display device using a light emitting element such as an organic EL device or the like in pixels, each pixel has a function of correcting for the threshold voltage of a driving transistor and a function of correcting for secular variations of the organic EL device (bootstrap operation), and preferably each pixel has another function of correcting for the mobility of the driving transistor. Thus high picture quality can be obtained. Because the conventional pixel circuit having such diverse correcting functions has a large number of constituent elements, the layout area of the existing pixel circuit becomes large, and the conventional pixel circuit is thus unsuitable for the achievement of high definition of a display. On the other hand, the present invention can reduce the number of constituent elements to two transistors and one capacitance by switching the power supply voltage and the potential of the signal line, and thus reduce the layout area of a pixel. It is thereby possible to provide a high-quality and high-definition flat display.

When various correcting functions are to be realized while the number of elements is reduced, settings and control sequences of the potentials of the feeder and the signal line become delicate and complex. Thus, in some cases, nonuniformity of light emission luminance may occur between pixels, which impairs picture quality. Accordingly, the present invention prevents the nonuniformity of light emission luminance from appearing between pixels by properly setting the reference potential of the signal line and the second potential of the feeder in particular. Specifically, the reference potential of the signal line and the second potential of the feeder are set in advance such that the source potential of the driving transistor immediately before a start of light emission of the light emitting element does not exceed the threshold voltage of the light emitting element. If the source potential of the driving transistor is set to exceed the threshold voltage of the light emitting element, the gate-to-source voltage of the driving transistor is expanded at a stage of signal writing, and an amount of current supplied by the driving transistor is correspondingly increased, so that the light emission luminance is increased.

### BRIEF DESCRIPTION OF THE DRAWINGS

FIG. 1 is a block diagram showing a general configuration of a display device according to an embodiment of the present invention;

FIG. 2 is a circuit diagram showing a configuration of a pixel formed in the display device shown in FIG. 1;

FIG. 3 is a timing chart of assistance in explaining operation of the pixel shown in FIG. 2;

FIGS. 4A and 4B are waveform charts of assistance in explaining the present invention; and

FIGS. 5A and 5B are waveform charts of assistance in explaining the present invention.

### DETAILED DESCRIPTION OF THE PREFERRED EMBODIMENTS

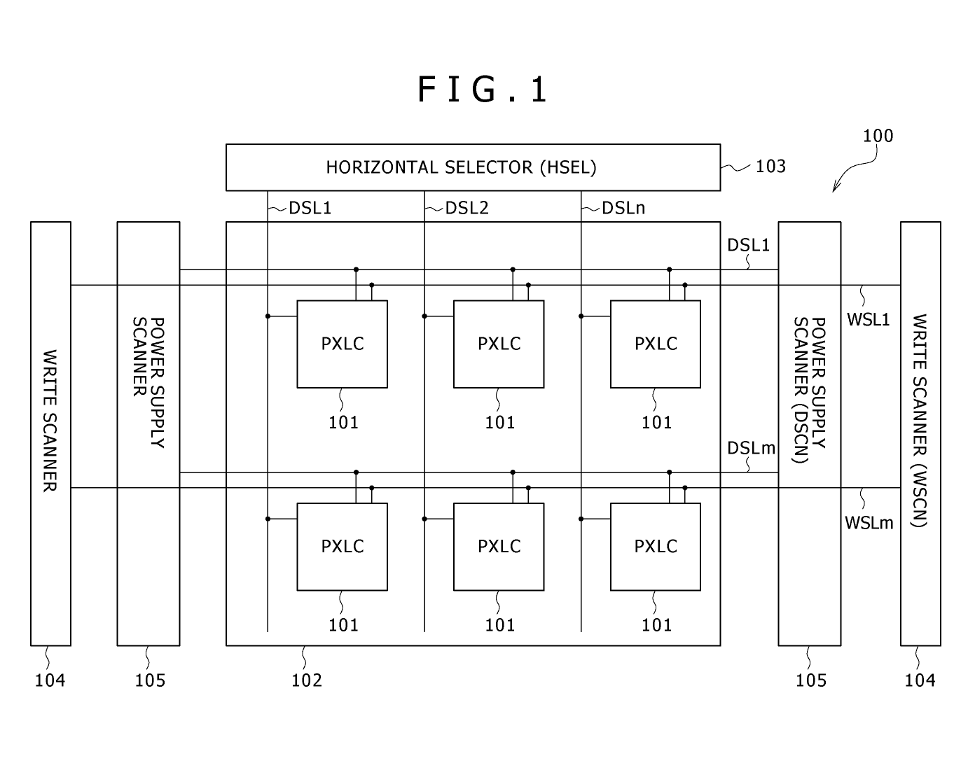

Preferred embodiments of the present invention will hereinafter be described in detail with reference to the drawings. FIG. 1 is a block diagram showing a general configuration of a display device according to an embodiment of the present invention. As shown in FIG. 1, the display device 100 includes a pixel array unit 102 and driving units (103, 104, and 105) for driving the pixel array unit 102. The pixel array unit 102 includes scanning lines WSL1 to WSLm in the form of rows, signal lines DTL1 to DTLn in the form of columns, pixels (PXLC) 101 in the form of a matrix which pixels are arranged at parts where the scanning lines WSL1 to WSLm intersect the signal lines DTL1 to DTLn, and feeders DSL1 to DSLm arranged in correspondence with the respective rows of the pixels 101. The driving units (103, 104, and 105) include: a controlling scanner (write scanner WSCN) 104 for sequentially supplying a control signal to the scanning lines WSL1 to WSLm to perform line-sequential scanning of the pixels 101 in row units; a power supply scanner (DSCN) 105 for supplying the feeders DSL1 to DSLm with a power supply voltage switching between a first potential (high potential) and a second potential (low potential) in accordance with the line-sequential scanning; and a signal selector (horizontal selector HSEL) 103 for supplying the signal lines DTL1 to DTLn in the form of columns with a signal potential of a video signal and a reference potential in accordance with the line-sequential scanning. Incidentally, in the present example, a pair of write scanners 104 is provided, and disposed on both a left edge and a right edge of the pixel array unit 102. The write scanners 104 simultaneously drive the scanning lines WSL arranged in the pixel array unit 102 from both the left side and the right side so as to suppress a shift in timing which shift is attendant on a delay in propagation of a control signal. Similarly, a power supply scanner 105 is provided on both the left side and the right side of the pixel array unit 102. The power supply scanners 105 simultaneously drive the feeders DSL from the left and the right to secure a sufficient amount of feed.

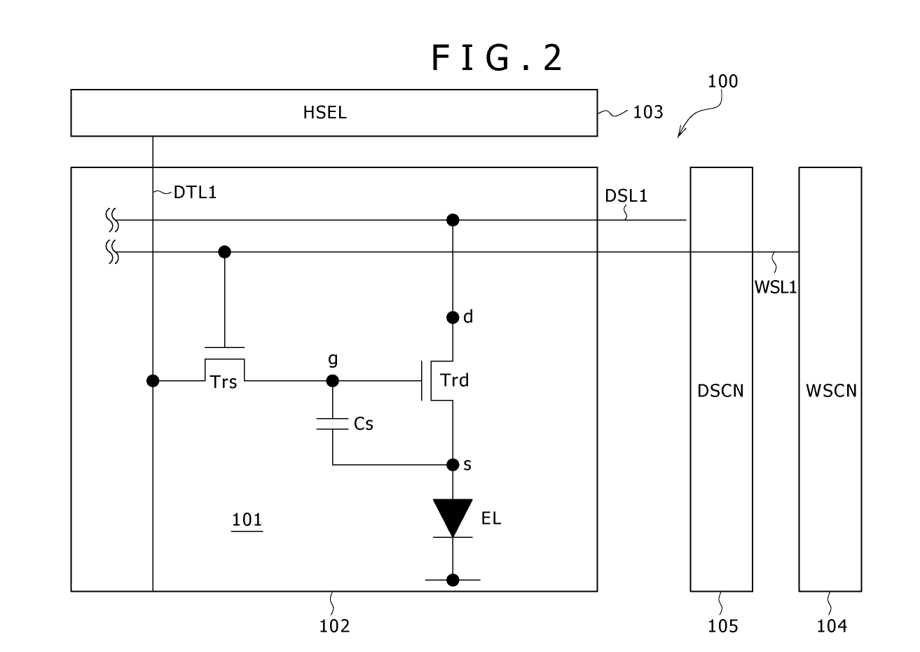

FIG. 2 is a circuit diagram showing a concrete configuration and a connecting relation of a pixel 101 included in the display device 100 shown in FIG. 1. Incidentally, in order to facilitate understanding, FIG. 2 shows only a pixel circuit 101 situated in a first row and a first column in the pixel array unit 102. The pixel circuit 101 includes a light emitting element EL, a sampling transistor Trs, a driving transistor Trd, and a storage capacitor Cs. The light emitting element EL is for example formed by an organic EL device, and is of a two-terminal type having an anode and a cathode. The light emitting element EL has a predetermined threshold voltage value. A current flows through the light emitting element EL and the light emitting element EL starts emitting light when an anode potential exceeds the threshold voltage value with respect to a cathode potential.

The sampling transistor Trs has a gate connected to the scanning line WSL1. One of the source and the drain of the sampling transistor Trs is connected to the signal line DTL1, and the other is connected to the gate g of the driving transistor Trd. One of the source s and the drain d of the driving transistor Trd is connected to the anode of the light emitting element EL, and the other is connected to the feeder DSL1. In this example, the driving transistor Trd is of an N-channel type, and the drain d side of the driving transistor Trd is connected to the feeder DSL1, while the source s side of the driving transistor Trd is connected to the anode side of the light emitting element EL. Incidentally, the cathode of the light emitting element EL is set at a predetermined potential. The storage capacitor Cs is connected between the source s and the gate g of the driving transistor Trd. The storage capacitor Cs is configured to retain a gate voltage Vgs applied to the gate g of the driving transistor Trd. The driving transistor Trd basically operates in a saturation region. The driving transistor Trd supplies a driving current (drain current) Ids corresponding to the gate voltage Vgs to the light emitting element EL when the gate voltage Vgs exceeds the threshold voltage Vth of the driving transistor Trd.

The power supply scanner 105 switches the feeder DSL from the first potential (high potential) to the second potential (low potential) in predetermined timing. During a time period when the signal line DTL1 is at the reference potential, the controlling scanner (write scanner) 104 supplies a control signal to the scanning line WSL1 to make the sampling transistor Trs conduct and thereby apply the reference potential from the signal line DTL1 to the gate g of the driving transistor Trd, and the second potential (low potential) is set from the feeder DSL1 to the source s of the driving transistor Trd. Next, during the time period when the signal line DTL1 is at the reference potential, the power supply scanner 105 operates to switch the feeder DSL1 from the second potential (low potential) to the first potential (high potential) and thereby write a voltage corresponding to the threshold voltage Vth of the driving transistor Trd to the storage capacitor Cs. This voltage written to the storage capacitor Cs acts to cancel the threshold voltage of the driving transistor Trd. The driving transistor Trd in each pixel 101 can thereby cancel a variation in the threshold voltage. Next, during a time period when the signal line DTL1 is at a signal potential, the controlling scanner 104 supplies a control signal to the scanning line WSL1 to make the sampling transistor Trs conduct, whereby the signal potential is sampled and written to the storage capacitor Cs. Further, in timing in which the storage capacitor Cs holds the signal potential, the controlling scanner 104 cancels the application of the control signal to the scanning line WSL1 to set the sampling transistor Trs in a non-conducting state, whereby the gate g of the driving transistor Trd is electrically disconnected from the signal line DTL1.

The driving transistor Trd is supplied with a current from the feeder DSL1 at the first potential (high potential), and sends a driving current to the light emitting element EL according to the signal potential retained by the storage capacitor Cs. The light emitting element EL starts emitting light according to the driving current, and the gate potential of the driving transistor Trd is interlocked with the source potential of the driving transistor Trd so that the voltage Vgs between the gate g and the source s is maintained at a constant level. This is a so-called bootstrap operation. Irrespective of secular changes in the current/voltage characteristic of the light emitting element EL, the driving transistor Trd can operate as a constant-current source at all times to supply the driving current corresponding to the voltage Vgs to the light emitting element EL. In other words, even when the anode potential (the source potential of the driving transistor Trd) varies due to a secular change in the current/voltage characteristic of the light emitting element EL, the driving transistor Trd can supply a constant current corresponding to the voltage Vgs to the light emitting element EL without being affected by the variation of the anode potential. Incidentally, when the storage capacitor Cs retains the signal potential, the sampling transistor Trs adds a correction for the mobility μ of the driving transistor Trd to the signal potential.

As a characteristic point of the present invention, the reference potential of the signal line DTL and the second potential (low potential) of the feeder DSL are set in advance such that the source potential of the driving transistor Trd immediately before a start of light emission of the light emitting element EL does not exceed the threshold voltage of the light emitting element EL. When various correcting functions are to be realized while the number of elements is reduced, settings and control sequences of the potentials of the feeder and the signal line become delicate and complex, as described above. Thus, in some cases, nonuniformity of light emission luminance may occur between pixels, which impairs picture quality. Accordingly, the present invention prevents the nonuniformity of light emission luminance from appearing between pixels by properly setting the reference potential of the signal line and the second potential of the feeder in particular. Specifically, the reference potential of the signal line and the second potential of the feeder are set in advance such that the source potential of the driving transistor immediately before a start of light emission of the light emitting element does not exceed the threshold voltage of the light emitting element. If the source potential of the driving transistor is set to exceed the threshold voltage of the light emitting element, the gate-to-source voltage of the driving transistor is expanded at a stage of signal writing, and an amount of current supplied by the driving transistor is correspondingly increased, so that the light emission luminance becomes excessive.

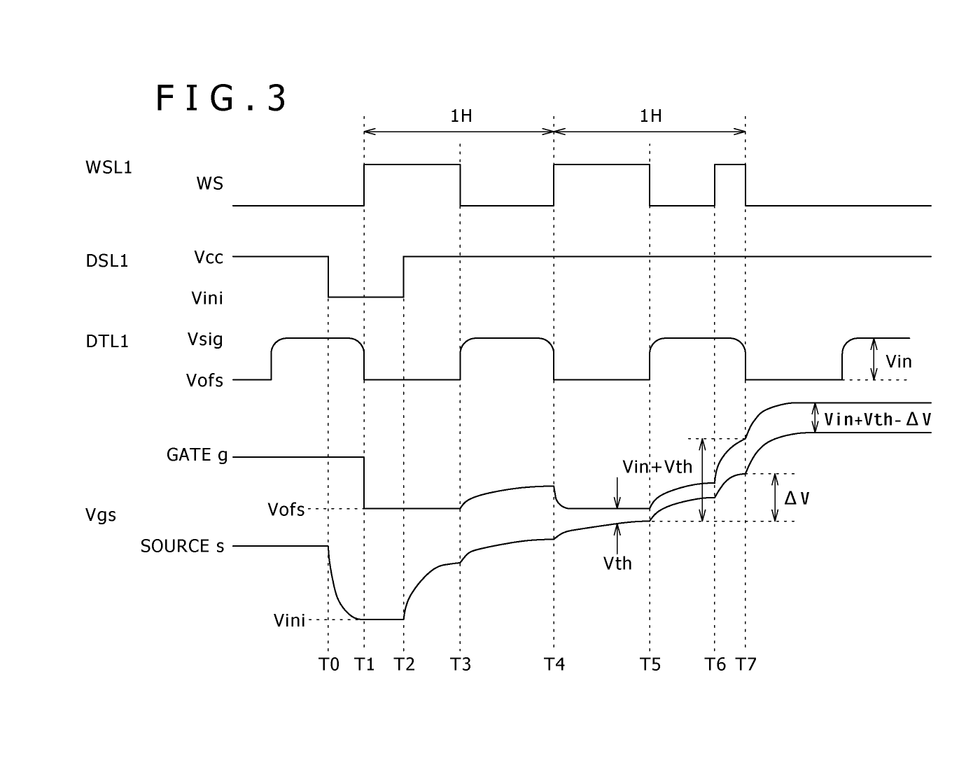

FIG. 3 is a timing chart of assistance in explaining the operation of the pixel circuit 101 shown in FIG. 2. With a time axis in common, FIG. 3 shows changes in potential of the scanning line WSL1, changes in potential of the feeder DSL1, and changes in potential of the signal line DTL1. The changes in potential of the scanning line WSL1 represent a control signal WS applied to the gate of the sampling transistor Trs. As shown in FIG. 3, the control signal WS is formed by a train of three pulses. The sampling transistor Trs conducts each time a pulse is input to the gate of the N-channel sampling transistor Trs. The feeder DSL1 switches between a first potential Vcc on a high potential side and a second potential Vini on a low potential side. The potential of the signal line DTL1 switches between a signal potential Vsig and a reference potential Vofs in each horizontal period (1 H). In FIG. 3, a potential difference between the signal potential Vsig and the reference potential Vofs is denoted by Vin.

The timing chart of FIG. 3 also shows changes in the gate potential and the source potential of the driving transistor Trd in parallel with the above-mentioned changes in potential of the scanning line WSL1, the feeder DSL1, and the signal line DTL1. Incidentally, the gate voltage Vgs representing a difference between the gate potential and the source potential is precisely a voltage applied across the storage capacitor Cs.

First, in timing T0, the potential of the feeder DSL1 is switched from the high potential Vcc to the low potential Vini. The source potential of the driving transistor Trd is thereby dropped to the low potential Vini. This low potential Vini is set lower than the cathode potential of the light emitting element EL. Therefore, at this point in time, the potential on the anode side of the light emitting element EL (that is, the source side of the driving transistor Trd) is lower than the potential on the cathode side of the light emitting element EL, so that a reverse bias is applied to the light emitting element EL.

Next, in timing T1, the scanning line WSL1 is set to a high level to turn on the sampling transistor Trs. At this time, the signal line DTL1 is at the reference potential Vofs. By thus turning on the sampling transistor Trs when the signal line DTL1 is at the reference potential Vofs, the reference potential Vofs is written to the gate g of the driving transistor Trd. In this case, Vgs=Vofs−Vini is set sufficiently higher than the threshold voltage Vth of the driving transistor Trd. The driving transistor Trd is therefore set in an on state at this point in time.

While the signal line DTL1 continues being at the reference potential Vofs, the feeder DSL1 is switched from the low potential Vini to the high potential Vcc in timing T2. At this time, the sampling transistor Trs is still in the on state, and thus the gate g of the driving transistor Trd is fixed at the reference potential Vofs. When the feeder DSL1 is switched from the low potential Vini to the high potential Vcc in timing T2, a driving current flows between the source s and the drain d of the driving transistor Trd with the gate g of the driving transistor Trd controlled to be at the reference potential Vofs. However, this driving current does not flow into the light emitting element EL in a reverse-biased state, and is used entirely to charge the storage capacitor Cs and other capacitances. Thereby the potential of the source s of the driving transistor Trd is raised.

Thereafter, in timing T3, the control signal WS is set to a low level to turn off the sampling transistor Trs, and the signal line DTL1 is switched from the reference potential Vofs to the signal potential Vsig. Thus turning off the sampling transistor Trs when a period of the reference potential Vofs of about H/2 ends and before the signal line DTL1 rises to the signal potential Vsig prevents the signal potential Vsig from being written to the storage capacitor Cs. A period from timing T2 to timing T3 described above is a first threshold voltage correcting period.

When a time of H/2 passes again from timing T3, the control signal WS is set to the high level again in timing T4 to turn on the sampling transistor Trs. During a period from timing T3 to timing T4, the gate g of the driving transistor Trd is disconnected from the signal line DTL1, and therefore the driving transistor Trd performs a bootstrap operation, so that the potentials of the gate g and the source s are each shifted upward. In timing T4, the sampling transistor Trs is turned on during a time period when the signal line DTL1 is at the reference potential Vofs, and thus a second threshold voltage correcting period begins. While the gate g of the driving transistor Trd is controlled to be at the reference potential Vofs, the source potential is raised. When the voltage Vgs eventually becomes the threshold voltage Vth, the driving transistor Trd is cut off. The value of the voltage Vgs at the time of the cutoff is written across the storage capacitor Cs. That is, as a result of threshold voltage correcting operation, the voltage corresponding to the threshold voltage Vth of the driving transistor Trd is written to the storage capacitor Cs. In the example shown in FIG. 3, the writing of the threshold voltage Vth is completed by performing the threshold voltage correcting operation twice. The threshold voltage correcting operation can be further repeated when performing the threshold voltage correcting operation twice is not sufficient. Conversely, when the first threshold voltage correcting operation is sufficient to write the threshold voltage Vth to the storage capacitor, it is not necessary to perform a further threshold voltage correcting operation.

In timing T5, the signal line DTL1 is switched from the reference potential Vofs to the signal potential Vsig again, while the control signal WS is set to the low level to turn off the sampling transistor Trs. A period from timing T4 to timing T5 is the second threshold voltage correcting period described above.

Next, during a period from timing T6 to timing T7, the control signal WS is at the high level again, so that the sampling transistor Trs is turned on. At this point in time, the signal line DTL1 has been switched from the reference potential Vofs to the signal potential Vsig. The signal potential Vsig is therefore written to the gate g of the driving transistor Trd via the sampling transistor Trs in a conducting state. Thus, the timings T6 and T7 define a signal potential writing time. In this period T6-T7, the difference Vin between the signal potential Vsig and the reference potential Vofs is written to the storage capacitor Cs in such a way as to be added to the threshold voltage Vth, and a voltage ΔV for mobility correction is subtracted from the voltage retained by the storage capacitor Cs.

As described above, in the sampling period T6-T7, the scanning line WSL1 makes a transition to the high level to set the sampling transistor Trs in an on state. The gate potential of the driving transistor Trd therefore becomes the signal potential Vsig. Because the light emitting element EL is still in the reverse-biased state, the current flowing between the drain d and the source s of the driving transistor Trd flows to the storage capacitor Cs to start charging the storage capacitor Cs. Therefore, in the period T6-T7, the source potential of the driving transistor Trd also starts rising, and eventually the gate voltage Vgs of the driving transistor Trd becomes Vin+Vth−ΔV. Thus, the sampling of the potential difference Vin and the adjustment of the amount of correction ΔV are performed simultaneously. The greater the potential difference Vin, the larger the current flowing through the driving transistor, and the higher the absolute value of the voltage ΔV. A mobility correction is therefore performed according to the level of the signal potential. In addition, when the potential difference Vin is set constant, the higher the mobility μ of the driving transistor Trd, the higher the absolute value of the voltage ΔV. In other words, the higher the mobility μ, the larger the amount of negative feedback ΔV. Therefore a variation in mobility μ of each pixel can be eliminated.

In timing T7, the scanning line WSL1 returns to the low level to set the sampling transistor Trs in an off state. The gate g of the driving transistor Trd is thereby disconnected from the signal line DTL1. At the same time, a driving current starts flowing through the light emitting element EL. The anode potential of the light emitting element EL (that is, the source potential of the driving transistor Trd) thereby rises. The rise in anode potential of the light emitting element EL is none other than the rise in source potential of the driving transistor Trd. When the source potential of the driving transistor Trd rises, the bootstrap operation of the storage capacitor Cs makes the gate potential of the driving transistor Trd also rise in such a manner as to be interlocked with the source potential of the driving transistor Trd. The amount of rise of the gate potential is equal to the amount of rise of the source potential. Hence, during a light emission period, the gate voltage Vgs of the driving transistor Trd is maintained at a constant level Vin+Vth−ΔV. Of this gate voltage Vgs, Vin is a part corresponding to the signal potential of the video signal, Vth is a part for canceling the threshold voltage of the driving transistor Trd, and ΔV is a correction term for the mobility of the same driving transistor Trd.

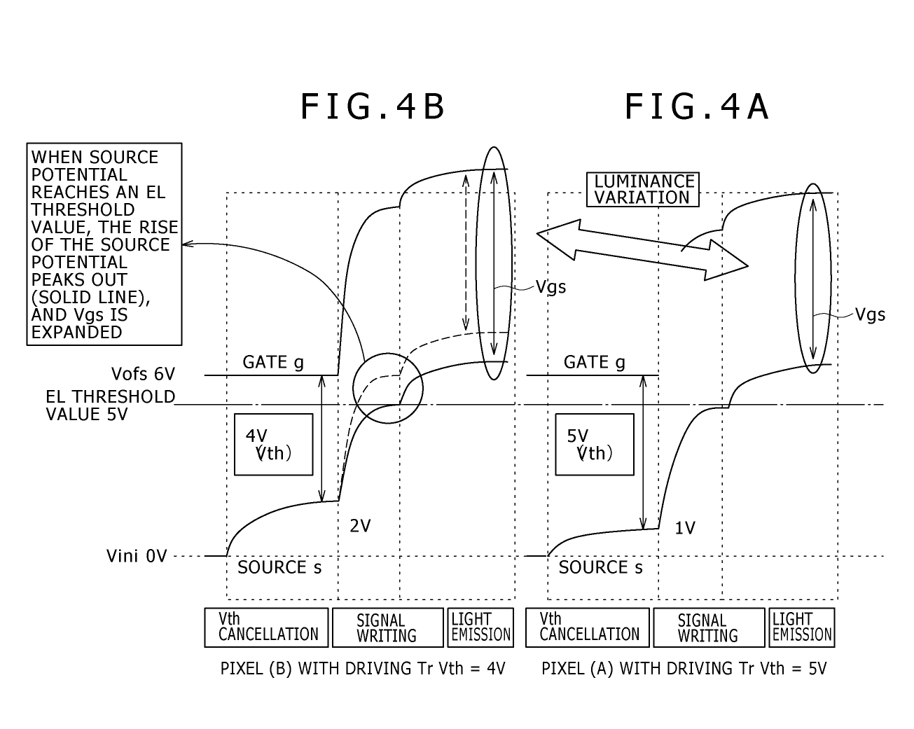

FIGS. 4A and 4B are a graph of assistance in explaining principles of the present invention. In order to clarify the background of the invention, the graph shows a state before optimum settings of the potential of the signal line and the potential of the feeder are made. The graph is a waveform chart showing potential changes of the gate g and the source s of the driving transistor included in the pixel circuit in operation. FIG. 4A shows the operation of a pixel in which the threshold voltage Vth of the driving transistor is at substantially an average of 5 V. FIG. 4B illustrates a case where the threshold voltage Vth of the driving transistor is at a lowest level of 4 V. Each of the graphs shows changes in gate potential and source potential during a period from a Vth canceling operation through a signal writing operation to a light emitting operation. In this example, the threshold voltage of the light emitting element EL is 5 V, the reference potential Vofs of the signal line is 6 V, and the second potential (low potential) Vini of the feeder is set at 0 V. The reference potential Vofs and the potential Vini are each set higher before application of the present invention.

Description will first be made of the operation of the pixel (A). In a preparation period before the cancellation of the threshold voltage Vth, the gate g of the driving transistor Trd is set at Vofs=6 V, and the source s of the driving transistor Trd is set at the potential Vini of 0 V. The gate voltage Vgs at this point in time is 6 V, and is set higher than the threshold voltage Vth=5 V of the driving transistor Trd. Incidentally, the source potential of 0V is set sufficiently lower than the threshold voltage of 5 V of the light emitting element EL. The light emitting element EL at this point in time is in a reverse-biased state, and no current flows through the light emitting element EL.

Then, after the operation of canceling the threshold voltage Vth begins, the gate g is controlled to be at Vofs=6 V, while the source potential rises. When the voltage Vgs becomes exactly 5 V, the driving transistor is cut off. That is, the operation of canceling the threshold voltage Vth is performed, so that 5 V is written across the storage capacitor Cs.

Then the signal wiring operation begins. Incidentally, while the operation of canceling the threshold voltage Vth is performed a plurality of times before the signal wiring operation in the timing chart of FIG. 3, the operation of canceling the threshold voltage Vth is performed only once in order to simplify description in the present example. In the signal writing operation, a signal potential is written from the signal line to the gate g, so that the gate potential of the driving transistor rises. At this time, a current flowing through the driving transistor is negatively fed back to the storage capacitor side, so that the potential of the source s also rises. The amount ΔV of this rise is an amount of correction for the mobility μ of the driving transistor. The amount ΔV of rise in the example of FIG. 4A is a little less than 4 V. The source potential is 0 V before the cancellation of the threshold voltage Vth, and is 1 V after the cancellation of the threshold voltage Vth. This signal writing further raises the source potential from 1 V by a little less than 4 V. Even so, the source potential is slightly lower than the threshold voltage of 5 V of the light emitting element EL at a point in time when the signal writing operation is completed.

The light emitting operation begins after the signal writing. The gate voltage Vgs written to the storage capacitor Cs at the stage where the signal writing is completed is fixed as it is, and thus the driving transistor Trd operates as a constant-current source to supply a driving current corresponding to the gate voltage Vgs to the light emitting element EL. Thereby the anode potential of the light emitting element EL rises, and a current starts flowing when the anode potential of the light emitting element EL exceeds the threshold value of 5 V. The anode potential is further raised when the current flows. However, the gate voltage Vgs is maintained at a constant level by the above-described bootstrap operation.

Description will next be made of the operation of a pixel (B) in which the threshold voltage Vth of a driving transistor is a lowest level of 4 V. In a preparation stage, the gate g of the driving transistor is set at Vofs=6 V, and the source s of the driving transistor is set at the potential Vini of 0 V. After the operation of canceling the threshold voltage Vth begins, the potential of the source s rises until the voltage Vgs becomes the threshold voltage Vth=4 V. That is, at a stage where the operation of canceling the threshold voltage Vth ends, the source potential rises from 0 V to 2 V. After the signal writing operation then begins, the potential of the gate g rises according to a signal potential supplied from the signal line, and the potential of the source s is also to rise by a little less than 4 V as an amount of negative feedback. However, when the source potential is to rise from 2 V by a little less than ΔV=4 V, the source potential reaches the threshold voltage of 5 V of the light emitting element EL at a stage where the source potential rises by 3 V, and thus the source potential peaks out. That is, when the anode potential of the light emitting element EL reaches the threshold voltage of 5 V of the light emitting element EL, the light emitting element EL is turned on, so that the rise of the anode potential (that is, the rise of the source potential) peaks out. Thus, in the signal writing operation, the gate g rises according to the signal potential, while the source potential peaks out, so that the voltage Vgs is expanded as compared with the case of the pixel (A). This is a factor in causing luminance variations. That is, even when signal potentials at a same level are written to the pixel A and the pixel B, the voltage Vgs of the pixel B is expanded as compared with the pixel A, so that the pixel B emits brighter light than the pixel A. This occurs in pixels along the scanning line, and appears as stripe nonuniformity on the screen, thus impairing picture quality.

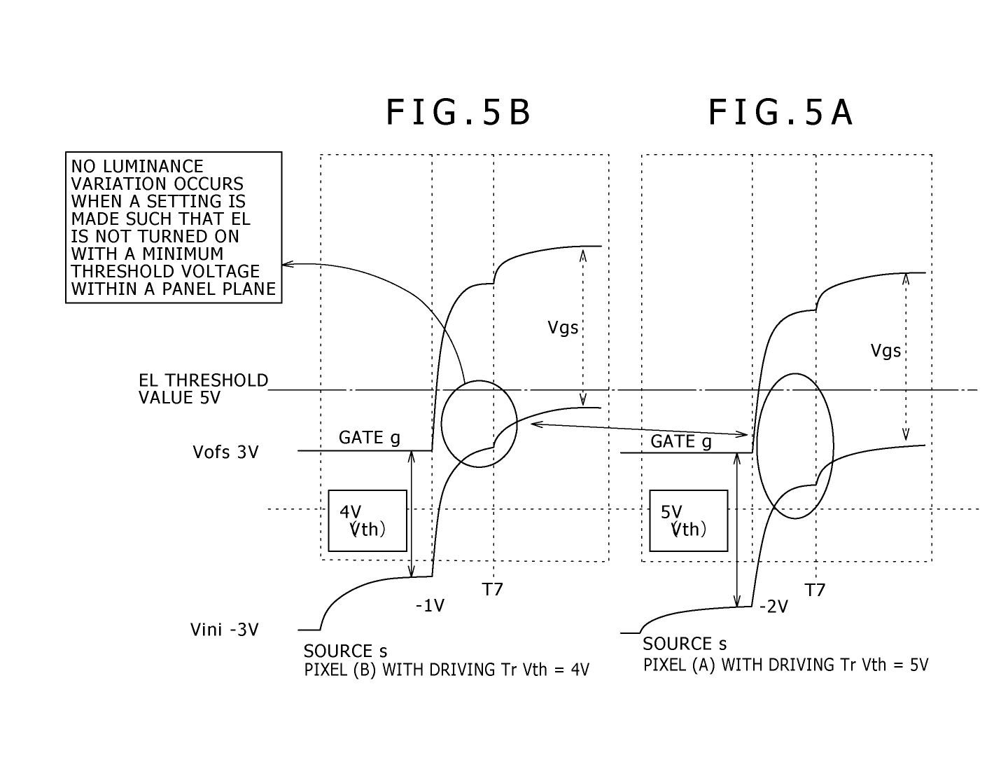

FIGS. 5A and 5B are waveform charts showing potential settings and the operation of pixels after a measure is taken according to the present invention. In order to facilitate understanding, a notation corresponding to that of the waveform charts of FIGS. 4A and 4B is adopted. In the present invention, the reference potential Vofs and the potential Vini are sufficiently lowered to prevent the light emitting element EL from being turned on during the signal writing operation. In the example of FIGS. 5A and 5B, the reference potential Vofs of the signal line is lowered from the state of FIGS. 4A and 4B to 3 V, and the second potential Vini of the feeder is lowered from the state of FIGS. 4A and 4B to −3 V. The optimum settings of FIGS. 5A and 5B are made by lowering each of the potentials from the state of FIGS. 4A and 4B by 3 V. The light emitting element EL is thereby prevented from being turned on too early in not only the pixel (A) in which the threshold voltage Vth of the driving transistor is an average value of 5 V but also the pixel (B) in which the threshold voltage Vth of the driving transistor is a lowest level of 4 V.

In the pixel (B), for example, at a preparation stage before the threshold voltage correcting operation begins, the gate potential of the driving transistor is set at the reference potential Vofs=3 V, and the source potential of the driving transistor is set at the potential Vini =−3 V. Next, after the threshold voltage correcting operation begins, the potential of the source s rises while the potential of the gate g is maintained. The source potential stops rising when the voltage Vgs becomes exactly 4 V. The level of the source potential is −1 V. Next, after the signal writing operation begins, the potential of the gate g rises according to the signal potential, and the source potential also rises by an amount ΔV of negative feedback, which is a little less than 4 V. At a stage where the signal writing operation ends, the source potential of the source s rises from −1 V to about 3 V. The level of 3 V is lower than the threshold voltage of 5 V of the light emitting element EL. Thus, the light emitting element EL is not turned on too early, and the source potential can rise without peaking out. Therefore, in timing T7 in which the writing operation ends, the gate voltage Vgs occurring between the source s and the gate g of the driving transistor is not expanded at all. The gate voltage Vgs is equal to the gate voltage Vgs in the case of the pixel (A) in which the threshold voltage is normal. Therefore no variation in luminance occurs. Thus, in the present invention, the reference potential Vofs of the signal line DTL and the second potential Vini of the feeder DSL are set lower so that the source potential of the driving transistor Trd immediately before a start of light emission of the light emitting element EL (that is, timing T7) does not exceed the threshold voltage of the light emitting element EL (that is, does not peak out in timing T7). However, setting the reference potential Vofs of the signal line DTL and the second potential Vini of the feeder DSL too low would add a load to a signal source and a power supply side, and also increase power consumption. It is thus undesirable to make the reference potential Vofs and the second potential Vini lower than necessary. Hence, it suffices to lower the reference potential Vofs and the second potential Vini to such a degree that the light emitting elements in all the pixels are not turned on during the signal writing period. Lowering the reference potential Vofs to an excessive degree would widen a difference between the signal potential Vsig and the reference potential Vofs, and thus increase a load on a signal selector side. In addition, making the second potential Vini lower than necessary would widen a difference between the potential Vcc and the potential Vini, and thus increase a load on the power supply scanner 105 side. By thus grasping the minimum threshold value of a driving transistor within the panel plane, an amount of rise of the source potential as a result of signal writing, and the threshold voltage of the light emitting element EL, and properly adjusting the reference potential Vofs and the second potential Vini according to these conditions, it is possible to avoid the turning on of the light emitting element during the signal writing period, and suppress variations in luminance.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a pixel array unit; and
a driving unit configured to drive said pixel array unit; wherein
said pixel array unit includes
scanning lines in a form of rows,
signal lines in a form of columns,
pixels in a form of a matrix, said pixels being arranged at parts where the scanning lines intersect the signal lines, and
feeders arranged in correspondence with respective rows of the pixels,
said driving unit includes
a controlling scanner configured to sequentially supply a control signal to each scanning line and perform line-sequential scanning of the pixels in row units,
a power supply scanner configured to supply each feeder with a power supply voltage switching between a first potential and a second potential in accordance with said line-sequential scanning, and
a signal selector configured to supply the signal lines in the form of columns with a signal potential of a video signal and a reference potential in accordance with said line-sequential scanning,
said pixels each include a light emitting element, a sampling transistor, a driving transistor, and a storage capacitor,
a gate of said sampling transistor is connected to said scanning line, one of a source and a drain of said sampling transistor is connected to said signal line, and the other is connected to a gate of said driving transistor,
one of a source and a drain of said driving transistor is connected to said light emitting element, and the other is connected to said feeder,
said storage capacitor is connected between the source and the gate of said driving transistor,
said power supply scanner switches said feeder from the first potential to the second potential in predetermined timing,
during a time period when said signal line is at the reference potential, said controlling scanner supplies a control signal to said scanning line to make said sampling transistor conduct and apply the reference potential from said signal line to the gate of said driving transistor, and the second potential is set from said feeder to the source of said driving transistor,
next, said power supply scanner operates to switch said feeder from the second potential to the first potential during the time period when said signal line is at the reference potential, and write a voltage corresponding to a threshold voltage of said driving transistor to said storage capacitor,
next, during a time period when said signal line is at a signal potential, said controlling scanner supplies a control signal to said scanning line to make said sampling transistor conduct, whereby said signal potential is sampled and written to said storage capacitor, and in timing in which said storage capacitor holds the signal potential, said controlling scanner cancels application of the control signal to said scanning line to set said sampling transistor in a non-conducting state, whereby the gate of said driving transistor is electrically disconnected from said signal line,
said driving transistor is supplied with a current from said feeder at the first potential, and sends a driving current to said light emitting element according to the signal potential retained by said storage capacitor,
said light emitting element starts emitting light according to the driving current, and a gate potential of said driving transistor is interlocked with a source potential of said driving transistor, whereby a voltage between the gate and the source is maintained at a constant level, and
the reference potential of said signal line and the second potential of said feeder are set in advance such that the source potential of said driving transistor immediately before a start of light emission of said light emitting element is prevented from exceeding a threshold voltage of said light emitting element.

2. The display device according to claim 1,
wherein when said storage capacitor retains the signal potential, said sampling transistor adds a correction for mobility of said driving transistor to the signal potential.

3. A driving method of a display device, said display device including a pixel array unit, and a driving unit configured to drive said pixel array unit, said pixel array unit including scanning lines in a form of rows, signal lines in a form of columns, pixels in a form of a matrix, said pixels being arranged at parts where the scanning lines intersect the signal lines, and feeders arranged in correspondence with respective rows of the pixels, said driving unit including a controlling scanner configured to sequentially supply a control signal to each scanning line and perform line-sequential scanning of the pixels in row units, a power supply scanner configured to supply each feeder with a power supply voltage switching between a first potential and a second potential in accordance with said line-sequential scanning, and a signal selector configured to supply the signal lines in the form of columns with a signal potential of a video signal and a reference potential in accordance with said line-sequential scanning, said pixels each including a light emitting element, a sampling transistor, a driving transistor, and a storage capacitor, a gate of said sampling transistor being connected to said scanning line, one of a source and a drain of said sampling transistor being connected to said signal line, and the other being connected to a gate of said driving transistor, one of a source and a drain of said driving transistor being connected to said light emitting element, and the other being connected to said feeder, and said storage capacitor being connected between the source and the gate of said driving transistor, said driving method comprising the steps of:
said power supply scanner switching said feeder from the first potential to the second potential in predetermined timing;
during a time period when said signal line is at the reference potential, said controlling scanner supplying a control signal to said scanning line to make said sampling transistor conduct and apply the reference potential from said signal line to the gate of said driving transistor, and setting the second potential from said feeder to the source of said driving transistor;
next, said power supply scanner operating to switch said feeder from the second potential to the first potential during the time period when said signal line is at the reference potential, and write a voltage corresponding to a threshold voltage of said driving transistor to said storage capacitor;
next, during a time period when said signal line is at a signal potential, said controlling scanner supplying a control signal to said scanning line to make said sampling transistor conduct, whereby said signal potential is sampled and written to said storage capacitor, and in timing in which said storage capacitor holds the signal potential, said controlling scanner canceling application of the control signal to said scanning line to set said sampling transistor in a non-conducting state, whereby the gate of said driving transistor is electrically disconnected from said signal line,
said driving transistor being supplied with a current from said feeder at the first potential, and sending a driving current to said light emitting element according to the signal potential retained by said storage capacitor,
said light emitting element starting emitting light according to the driving current, and interlocking a gate potential of said driving transistor with a source potential of said driving transistor, whereby a voltage between the gate and the source is maintained at a constant level, and
setting the reference potential of said signal line and the second potential of said feeder in advance such that the source potential of said driving transistor immediately before a start of light emission of said light emitting element is prevented from exceeding a threshold voltage of said light emitting element.
